(19) United States
(12) Patent Application Publication
(10) Pub. No.: US 2026/0110366 A1
(43) Pub. Date: Apr. 23, 2026

(54) CAGE APPARATUS FOR FLUID VALVES

(71) Applicant: Emerson Automation Solutions Final Control US LP, Houston, TX (US)

(72) Inventor: Vishwa Kalyanasundaram, Stafford, TX (US)

(21) Appl. No.: 18/919,059

(22) Filed: Oct. 17, 2024

(51) Int. Cl. F16K 1/42; F16K 17/04; F16K 27/02

(52) U.S. Cl. CPC F16K 17/0433; F16K 17/0413; F16K 27/0209; F16K 47/08

(57) ABSTRACT

Cage apparatus for fluid valves are disclosed. A cage apparatus includes a lip tapered toward a central axis of the cage, a mounting flange spaced from the lip, and a body between the lip and the mounting flange, the body including a plurality of first openings radially spaced about a circumference of the body.

### FIELD OF THE DISCLOSURE

This disclosure relates generally to process control devices and, more particularly, to cage apparatus for fluid valves.

### BACKGROUND

Pressure relief valves are used in a variety of applications to maintain a pressure within a system below a predetermined maximum pressure (e.g., a maximum fluid pressure). Specifically, if the pressure within the system exceeds a predetermined maximum pressure, the pressure relief valve vents a fluid or vapor to the atmosphere and/or other outlet until the pressure within the system decreases below the predetermined maximum pressure. The amount and rate at which the fluid or vapor is vented to the atmosphere is associated with the magnitude of the pressure within the container. A pressure relief valve may be selected for use with a system based on a design specification of the system such as a maximum pressure to which a pressure vessel within the system can be safely exposed.

### SUMMARY

A cage apparatus disclosed herein includes a lip tapered toward a central axis of the cage, a mounting flange spaced from the lip, and a body between the lip and the mounting flange, the body including a plurality of first openings radially spaced about a circumference of the body.

An example relief valve includes a valve body defining a fluid passageway between an inlet and an outlet and a nozzle coupled to the valve body. The nozzle defines the inlet of the valve body. The nozzle has a sealing surface defining an orifice of the fluid passageway. A disc holder is movably coupled to the valve body. The disc holder moves relative to the sealing surface to control fluid flow through the fluid passageway. A cage is coupled to the nozzle. The cage has a lip tapered toward a central axis of the cage.

An example valve trim assembly includes a disc, a disc holder to contain the disc, a nozzle, where the disc moves relative to the nozzle to control fluid flow through a fluid valve, and a cage having a central bore to slidably receive the disc. The cage has a first end and a second end opposite the first end and a side surface between the first and second ends. The side surface has a plurality of cage passages radially spaced relative to a longitudinal axis of the central bore. The cage includes a boss protruding within the central bore and extends from the second end toward the first end.

### BRIEF DESCRIPTION OF THE DRAWINGS

FIG. 1 is a perspective view of an example fluid valve in accordance with teachings of this disclosure.

FIG. 2 is a cross-sectional view of the example fluid valve of FIG. 1 with an example valve trim assembly disclosed herein in an example closed position.

FIG. 3A is a perspective view of an example cage disclosed herein.

FIG. 3B is a cross-sectional view of the example cage of FIG. 3A.

FIG. 4A is a cross-sectional view of the example fluid valve of FIG. 1 with the example valve trim assembly shown in an example open position.

FIG. 4B is an enlarged, partial cross-sectional view of the example relief valve of FIG. 4A.

FIG. 4C is a side view of the example fluid valve of FIGS. 4A and 4B shown from a perspective of an outlet of the example fluid valve.

FIG. 5 is a perspective view of another example cage disclosed herein.

FIG. 6 is a cross-sectional view of the example fluid valve of FIG. 1 with an example nozzle ring disclosed herein.

FIG. 7A is a perspective view of another example valve trim assembly disclosed herein shown in an example first position.

FIG. 7B is a perspective view of the example valve trim assembly of FIG. 7A shown in an example second position.

FIG. 7C is a perspective view of the example valve trim assembly of FIG. 7A shown in an example third position.

FIG. 8 is a cross-sectional view of the example fluid valve of FIG. 1 with the example valve trim assembly of FIG. 7A.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Spring-operated pressure relief valves are used extensively in systems and vessels for over pressure protection. The operation of a spring-operated, pressure relief valve involves compressing a spring a predetermined amount to control an opening point or a set pressure of a flow control member via a closing force. When a force exerted by a fluid on the flow control member is equivalent to and/or exceeds a closing force of the spring, the valve moves to an open position to allow fluid flow through the valve. An additional increase in fluid pressure can cause further opening of the valve. Conversely, a decrease in fluid pressure below a set pressure provided by the spring leads to closure of the valve to prevent or restrict fluid flow through the valve.

During opening of a relief valve, a flow control member can experience different effects as the flow control member moves between a fully closed position and a fully open position (e.g., a full lift position) based on a pressure of a fluid and/or a set pressure of the relief valve. For example, relief valves may not open (e.g., fully open) at a set pressure of the relief valve. As used herein, “set pressure” means a pressure at which the valve opens to provide a significant relief of the system pressure. For example, some relief valves can simmer during a first portion of a full lift stroke prior to popping open to a full lift stroke position. As used herein, “simmer or simmer pressure” means an audible or visible escape of fluid between a disc and a valve seat that occurs when the relief valve opens slightly. Thus, typically, a relief valve can simmer over a first portion of full lift (e.g., between one percent lift and 50 percent lift) prior to popping open to a full lift position.

To boost a pressure and reduce simmer, some relief valves employ a nozzle ring adjacent to a valve seat. The nozzle ring provides a huddling effect to improve an opening of a flow control member (e.g., a disc and disc holder). In operation, the nozzle ring causes stagnation of fluid flowing across a valve seat of a nozzle, resulting in an increased force or pressure imparted to a flow control member that causes the flow control member to pop (e.g., pop action) at a pressure that is closer (e.g., within 4 percent) to a cracking pressure of the valve (e.g., a pressure at which the valve starts to lift or move relative to the nozzle seat). As used herein, a “pop or pop action” of a valve means rapidly opening the valve to a certain desired lift (e.g., a full lift position). As used herein, “pop set pressure” means a set pressure where a first pop of a valve is observed. In addition to improving an opening of the relief valve, the nozzle ring can increase a blowdown characteristic of the valve. As used herein, “blowdown” means a pressure below a set pressure where the valve recloses after opening. Thus, the nozzle ring is effective at generating lift pressure during a first or lower portion of a full lift stroke length.

However, nozzle rings can have drawbacks relative to valve pop. For example, a nozzle ring provides a sudden increase in the fluid force by stagnating flow at low lifts. However, at higher lifts, the nozzle ring does not produce boost. For example, after the valve opens following an initial pop or boost provided by the nozzle ring, the huddling effect decreases with increase in lift as the valve opens further. As a result, a relief valve may pop at, for example, 40%-70% of lift and then may require further overpressure to reach full lift. As used herein, “overpressure” means a required increase in pressure above a set pressure to achieve the valves rated relieving capacity of a valve. In another words, the valve can have a pop action followed by a modulating action and, in some cases, can have another pop depending on a design or type of flow control member. Additionally, in some applications, a modulating action is desired throughout the valve while, in other applications, a pop action that moves the valve to its full rated lift is desired. In some instances, transition between rapid opening action to modulating action of the relief valve, coupled with inlet piping dynamics, can cause unwanted chatter and/or flutter during an upper lift portion or stroke (i.e., after the boost of pressure of the huddling effect diminishes as a flow control member continues to move further away from a valve seat and/or the nozzle ring). Thus, a nozzle ring is effective at providing a huddling effect at lower lift portions (e.g., between one percent and fifty percent) as opposed to higher lift portions (e.g., between fifty percent and one-hundred percent).

Examples disclosed herein improve performance of fluid valves (e.g., pressure relief valves). Specifically, example fluid valves disclosed herein employ a cage apparatus to provide a huddling effect. Example cage apparatus disclosed herein stagnate fluid flow inside a flow control member or disc holder, thereby increasing pressure and/or force to provide a pressure boost to affect a behavior of a valve at an upper or top segment of valve lift (e.g., between fifty percent and one-hundred percent lift). The cage apparatus can be positioned at different distances relative to a flow control member and/or disc holder of a valve to vary a huddling effect provided by the cage. For example, the greater a distance between the example cage apparatus and the flow control member, the greater the amount of pressure boost that can be generated by the huddling effect. Additionally, in some instances, example cage apparatus disclosed herein do not require use of a nozzle ring. In some examples, example cage apparatus disclosed herein can be used in combination with a nozzle ring. Some example cage apparatus disclosed herein include a flow adjustor ring that can adjust or vary a flow through area of the cage apparatus.

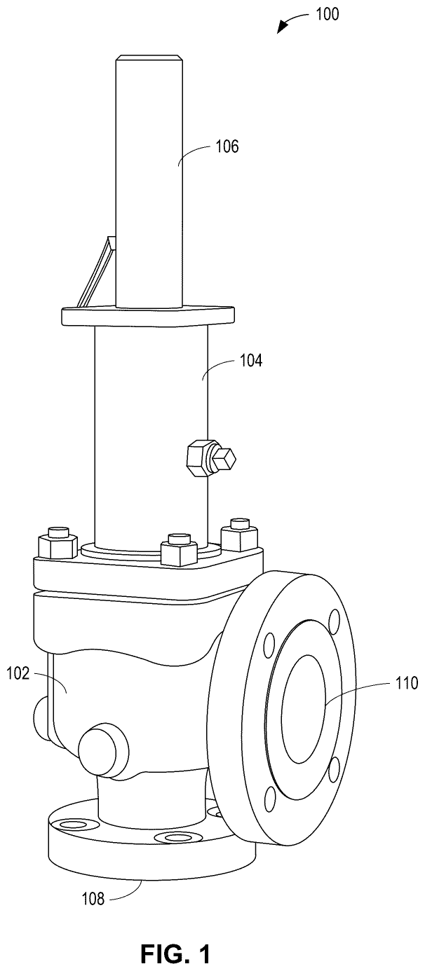

FIG. 1 illustrates an example fluid valve 100 (e.g., a pressure relief valve, a safety relief valve, etc.) in accordance with the teachings of this disclosure. The fluid valve 100 of the illustrated example includes a valve body 102 (e.g., valve body), a bonnet 104 and a cap 106. In this example, the valve body 102 defines an inlet 108 (e.g., an inlet port or opening) and an outlet 110 (e.g., an outlet port or opening). The fluid valve 100 fluid couples to a system upstream from the fluid valve 100. The upstream system can be, for example, a tank and/or other pressurized process fluid. In this particular example, the fluid valve 100 is implemented as a pressure relief valve that is utilized with a fluid (e.g., liquid, gas, vapor, two-phase fluid). In such examples, the fluid valve 100 operates to reduce pressure (e.g., fluid pressure) and/or prevent pressure from exceeding a predetermined maximum pressure (e.g., a maximum fluid pressure). For example, when pressure increases within a pressure vessel, the fluid valve 100 allows fluid to flow between the inlet 108 and the outlet 110. In some examples, the outlet 110 is fluidly coupled to the atmosphere, venting fluid to the atmosphere when the pressure in the fluid valve 100 exceeds the maximum pressure. Although the fluid valve 100 of the illustrated example is a pressure relief valve, example valve seat assemblies disclosed herein can be employed with safety valves, globe valves, rotary valves, and/or any other type of fluid valve having a poppet-style flow control member.

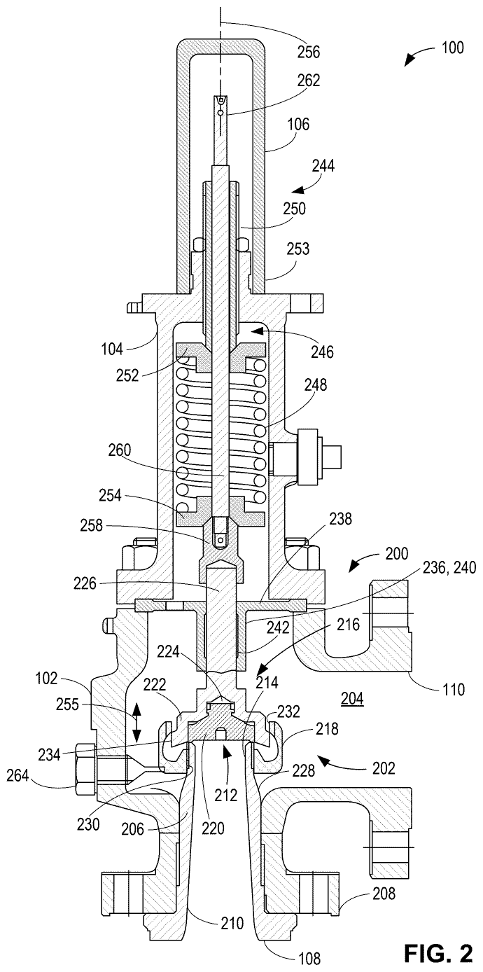

FIG. 2 is a cross-sectional view of the example fluid valve 100 shown in FIG. 1 shown in an example closed position 200 (e.g., a fully closed position). The fluid valve 100 of the illustrated example includes an example valve trim assembly 202 in accordance with teachings of this disclosure. In the illustrated example of FIG. 2, the valve body 102 defines a fluid flow passageway 204 between the inlet 108 and the outlet 110. In the closed position 200, fluid flow is prevented between the inlet 108 and the outlet 110. To control fluid flow through the fluid flow passageway 204, the fluid valve 100 includes the valve trim assembly 202 interposed in the fluid flow passageway 204 between the inlet 108 and the outlet 110.

The fluid valve 100 of the illustrated example includes a nozzle 206 coupled to the valve body 102. In particular, the nozzle 206 of the illustrated example is coupled to the inlet 108 of the valve body 102. Thus, the nozzle 206 defines the inlet 108 of the valve body 102. The nozzle 206 of the illustrated example is retained in the valve body 102. For example, the nozzle 206 of the illustrated example is (e.g., threadably) coupled to the valve body 102. In other examples, the nozzle 206 can be clamped to the valve body 102, fastened to a flange 208 of the valve body 102, and/or other coupled to the valve body 102 via any other means. The nozzle 206 includes a passageway or aperture 210 (e.g., a central aperture) that defines an orifice 212 and portions of the fluid flow passageway 204 upstream from the orifice 212. Additionally, the nozzle 206 includes a sealing surface or nozzle seat 214 (e.g., a valve seat) defining the orifice 212 at a first end of the nozzle 206 opposite a second end of the nozzle 206. Thus, the nozzle 206 of the illustrated example is an elongated cylindrical body that extends between the flange 208 of the valve body 102 and the valve trim assembly 202.

The valve trim assembly 202 of the illustrated example interacts with the nozzle 206 to control fluid flow through the fluid flow passageway 204. The valve trim assembly 202 of the illustrated example includes a flow control member 216 and a cage 218. In the illustrated example, the flow control member 216 includes a disc 220 coupled to a disc holder 222. The disc holder 222 includes a body defining a cavity 224 to receive the disc 220 and includes a stem 226 extending from the body. Thus, the disc holder 222 retains the disc 220. However, in some examples, the disc 220 can be omitted and the disc holder 222 interacts with the nozzle 206 to control fluid flow through the valve body 102. In some examples, the flow control member 216 can be a valve plug, a poppet, and/or any other fluid control member movable relative to the nozzle 206. The flow control member 216 is movably coupled relative to the valve body 102 and interacts with (e.g., moves relative to) the nozzle seat 214 to control fluid flow through the fluid flow passageway 204. The cage 218 of the illustrated example is coupled to the nozzle 206. Specifically, the cage 218 of the illustrated example is coupled to the first end of the nozzle 206. For example, the cage 218 of the illustrated example threadably couples to an outer surface 228 of the nozzle 206. The cage 218 includes an inner surface 230 having threads to threadably couple to the nozzle 206. The cage 218 of the illustrated example includes a central bore 232 (e.g., an opening or cavity) to receive (e.g., slidably receive) the flow control member 216 (e.g., the disc 220 and the disc holder 222). In other words, the disc holder 222 is at least partially received by the central bore 232 of the cage 218 such that the cage 218 encompasses or surrounds at least a portion of a side or outer surface 234 of the disc holder 222 and/or the disc 220. To maintain or lock a position of the cage 218 relative to the nozzle 206, the fluid valve 100 of the illustrated example includes a lock or blowdown screw 264. However, in other examples, the relief valve 100 can include a pin, lock nuts, screws, and/or any other fastener(s) for locking a position of the cage 218 relative to the nozzle 206.

Additionally, to retain and/or align the valve trim assembly 202 (e.g., centrally with a longitudinal axis 256) in the fluid flow passageway 204, the fluid valve 100 of the illustrated example includes a guide 236. The guide 236 of the illustrated example includes a flange 238 and an elongated or cylindrical body 240. The guide 236 is captured or retained (e.g., suspended) in the fluid flow passageway 204. Specifically, the flange 238 is captured between the valve body 102 and the bonnet 104. The cylindrical body 240 of the guide 236 has a central bore 242 that slidably receives the stem 226 of the disc holder 222. The guide 236 guides movement of the disc 220 during operation of the fluid valve 100. For example, the guide 236 enables only rectilinear movement of the disc 220 and/or disc holder 222 (e.g., vertical, or up or down in the orientation of FIG. 1).

To control movement of the valve trim assembly 202 relative to the orifice 212 based on a preset pressure, the fluid valve 100 of the illustrated example includes an adjustor assembly 244. The adjustor assembly 244 of the illustrated example is coupled to the bonnet 104. The bonnet 104 of the illustrated example defines a spring chamber 246 separate from the fluid flow passageway 204 to receive the adjustor assembly 244. The adjustor assembly 244 of the illustrated example includes a biasing element 248 (e.g., a spring, a coil spring, etc.) and an adjusting screw 250. The cap 106 (e.g., a cover) covers (e.g., protects) the adjusting screw 250. The adjusting screw 250 is (e.g., threadably) coupled to an aperture 253 at an upper surface of the bonnet 104. The biasing element 248 of the illustrated example is positioned in the spring chamber 246. Specifically, the biasing element 248 of the illustrated example is captured between a first spring seat 252 (e.g., upper spring washer) and a second spring seat 254 (e.g., a lower spring washer) opposite the first spring seat 252. The adjusting screw 250 of the illustrated example moves relative to the bonnet 104 in a rectilinear direction 255 (e.g., up and down directions in the orientation of FIG. 2) along the longitudinal axis 256 of the fluid valve 100 to adjust a force output of the biasing element 248 (e.g., compress or decompress the biasing element 248) and, thus, adjust (e.g., increase or decrease) a set pressure of the fluid valve 100. For example, the biasing element 248 has a known spring constant and is compressed a predetermined amount to generate the predetermined force exerted on the disc 220. The force exerted by the biasing element 248 maintains the position of the disc 220 (e.g., positioned on the nozzle seat 214) to prevent the flow of fluid through the fluid valve 100 until pressure at the inlet 108 creates a force on the disc 220 that overcomes the predetermined force or preset pressure provided by the biasing element 248.

In the illustrated example, the adjusting screw 250 engages the first spring seat 252 to adjust (e.g., compress or decompress) a position of the biasing element 248 relative to the second spring seat 254. The second spring seat 254 is operatively coupled to the valve trim assembly 202. Specifically, the second spring seat 254 is coupled to (e.g., fixed to or directly engaged with) a spindle 258. In turn, the spindle 258 is coupled to (e.g., receives a portion of) the stem 226 of the disc holder 222. The spindle 258 includes a stem 260 that extends through, and is slidably coupled to, the second spring seat 254, the first spring seat 252 and the adjusting screw 250. In some examples, the cap 106 can be removed and a lever can be coupled to an end 262 of the stem 260 to manually lift and/or move the valve trim assembly 202 relative to the nozzle 206.

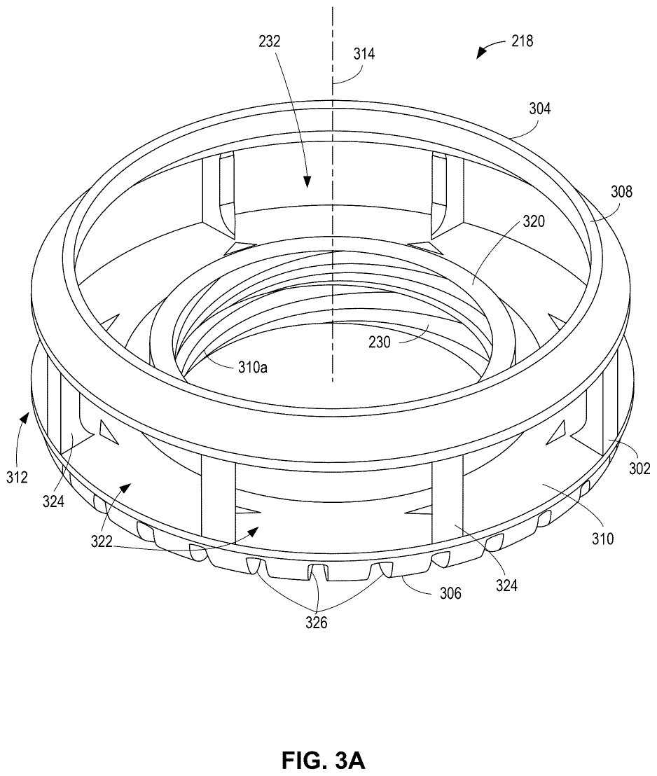

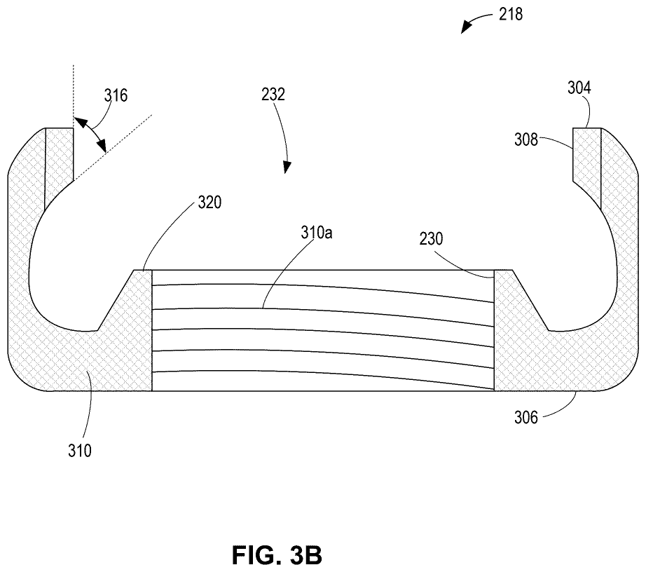

FIG. 3A is a perspective view of the cage 218. FIG. 3B is a cross-sectional view of the cage 218 similar to FIG. 2. Referring to FIGS. 3A and 3B, the cage 218 of the illustrated example defines a body 302 defining the central bore 232 to slidably receive the flow control member 216. For example, the cage 218 of the illustrated example is a cylindrical structure or body. The central bore 232 extends between a first end 304 of the cage 218 and a second end 306 of the cage 218 opposite the first end 304. The cage 218 of the illustrated example includes a lip 308, a base 310 (e.g., a mounting flange, a flange, etc.) and a side 312. The lip 308 is opposite the base 310 and the side 312 is between the lip 308 and the base 310. Thus, the lip 308 is spaced from the base 310 a distance defined by the side 312. The lip 308 of the illustrated example is positioned at or adjacent to the first end 304 of the cage 218 and the base 310 is positioned at or adjacent to the second end 306. The lip 308 of the illustrated example is an annular lip that tapers toward a longitudinal axis 314 (e.g., a central axis) of the cage 218 and/or the central bore 232. For example, the lip 308 (e.g., an inner surface of the lip 308 oriented toward the disc 220) has an angle 316 relative to vertical 318 (e.g., relative to the side 312 (e.g., an outer side surface) of the cage 218). In some examples, the angle 316 can be approximately between 40 degrees and 60 degrees. In some examples, the angle 316 can be any angle between zero degrees and ninety degrees. For instance, the lip 308 can be a vertical wall that protrudes parallel relative to the longitudinal axis 314, a horizontal wall that protrudes perpendicular to the longitudinal axis 314, and/or a wall positioned at any angle between vertical and horizontal. The lip 308 of the illustrated example can impact and/or adjust an amount of boost pressure and/or huddling effect at higher lifts. For instance, the smaller the angle 316 (e.g., 40 degrees, closer to zero degrees), the greater the huddling effect which, in turn, provides an increased boost pressure. The larger the angle 316 (e.g., 60 degrees, closer to 90 degrees) the smaller the huddling effect which, in turn, provides a decreased boost pressure.

The base 310 of the illustrated example includes a boss 320 that protrudes within the central bore 232 and extends from the second end 306 of the cage 218 toward the first end 304 of the cage 218 along the longitudinal axis 314. The base 310 defines the inner surface 230 of the cage 218 that includes threads 310a to threadably couple to the nozzle 206. Thus, the cage 218 can be adjusted (e.g., vertically) in the rectilinear direction 255 relative to the nozzle 206 based on a number of rotations of the cage 218 relative to the nozzle 206 when fastening the cage 218 and the nozzle 206. In this manner, a distance between the disc 220 and/or the disc holder 222 and the cage 218 can be varied for different process applications and/or desired opening characteristics of the fluid valve 100. For example, the cage 218 can be positioned at different distances (e.g., vertical distances) relative to the flow control member 216 and/or disc holder 222 to vary a huddling effect. For instance, the greater a distance between the cage 218 and the flow control member 216 and/or the disc holder 222, the greater an amount of pressure boost that can be generated by the huddling effect.

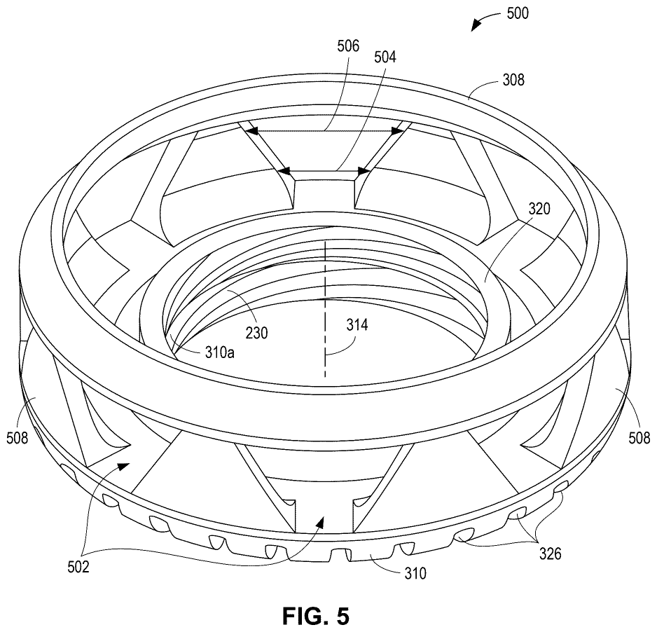

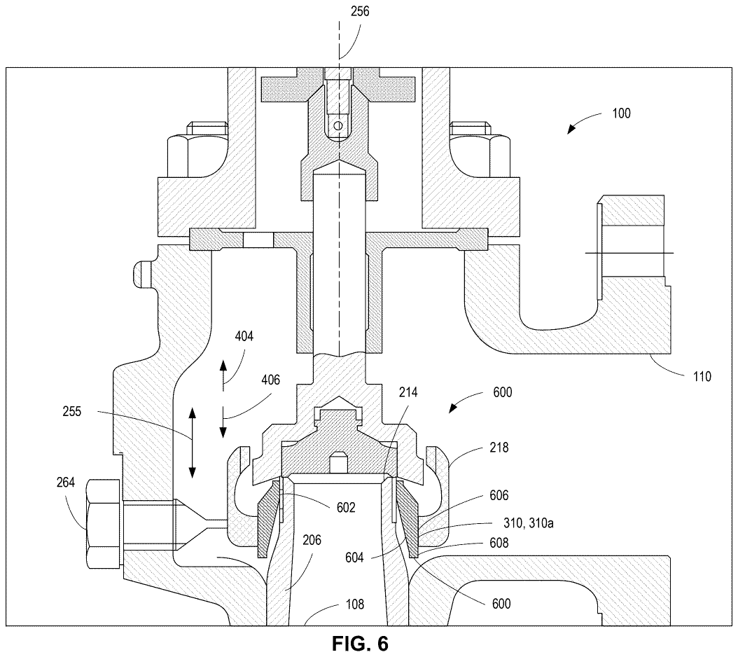

Additionally, the cage 218 of the illustrated example couples directly to the nozzle 206 without a nozzle ring. In some examples, the cage 218 can retrofit existing fluid valves in the field. In some examples, the cage 218 can be used with a nozzle ring (e.g., a nozzle ring 600 of FIG. 6).

The side 312 of the cage 218 of the illustrated example includes a plurality of cage passageways 322 (e.g., windows, openings, flow passages, etc.) through the side 312 of the cage 218. The cage passageways 322 are radially spaced relative to the longitudinal axis 314 of the central bore 232 of the cage (e.g., about a circumference of the cage 218).

Specifically, the cage passageways 322 extend through the side 312. The cage passageways 322 extend through the side 312 of the cage 218 to enable fluid flow from the inlet 108 to pass through towards the outlet 110. Walls or beams 324 (e.g., support beams) separate (e.g., are positioned between) the plurality of cage passageways 322. Specifically, the beams 324 of the illustrated example are radially spaced relative to the longitudinal axis 314. In other words, the beams 324 are spaced around a circumference of the cage 218. In the illustrated example, the beams 324 have a rectangular shape. The beams 324 extend vertically between the first end 304 and the second end 306 of the cage 218. In the illustrated example, a respective one of the cage passageways 322 extends between a respective pair of the beams 324, the first end 304 and the second end 306 of the cage 218. Thus, the cage passageways 322 of the illustrated example have a rectangular shape opening and collectively provide a flow area of the cage 218. Additionally, the base 310 and/or the second end 306 of the cage 218 includes a plurality of locating slots 326. A respective one of the locating slots 326 receives the blowdown screw 270 (FIG. 2) to lock or maintain a position of the cage 218 relative to the nozzle 206.

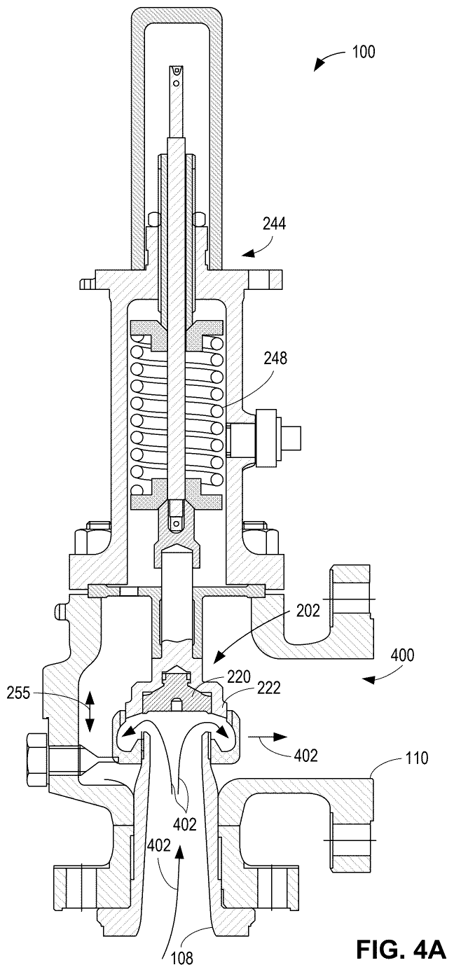

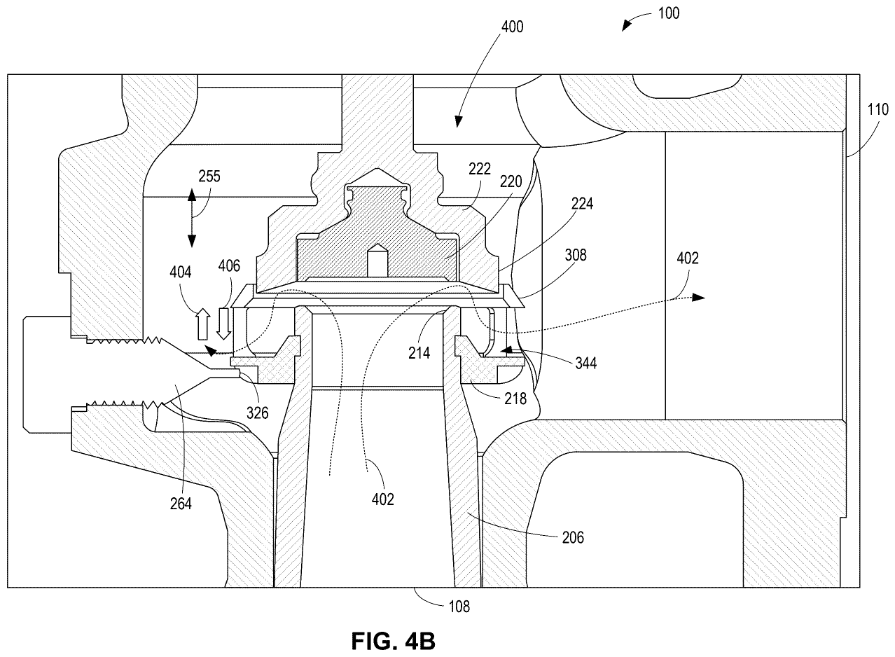

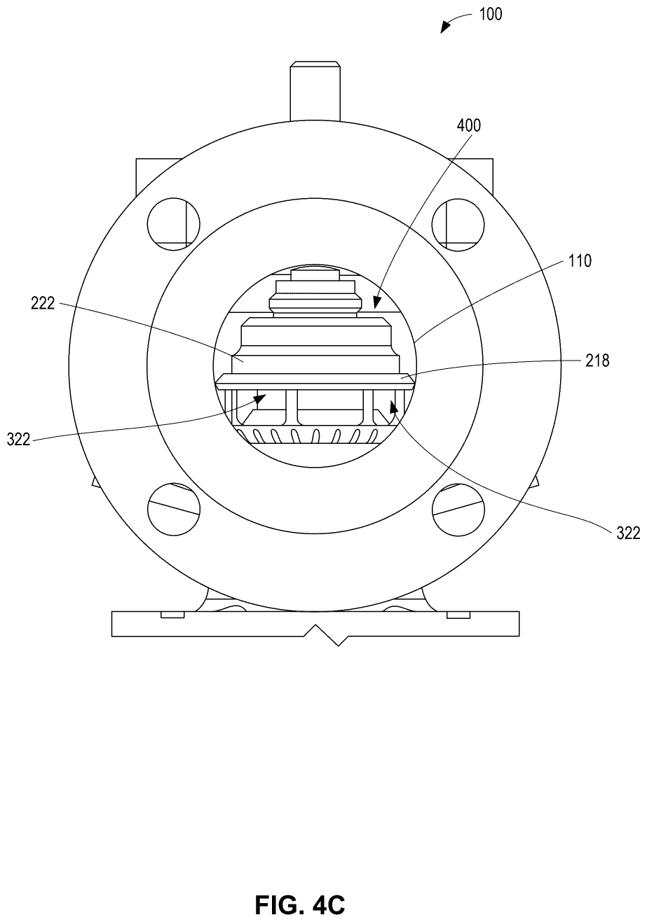

FIGS. 4A-4C illustrate the fluid valve 100 of FIGS. 1-3 in an example open position 400 (e.g., a fully open position). FIG. 4A is a cross-sectional view of the fluid valve 100 of FIGS. 1 and 2 shown in the open position 400. FIG. 4B is an enlarged view of the relief valve of FIG. 4A. FIG. 4C is a side view of the fluid valve 100 showing the cage 218 and the fluid flow passageway 204 from the outlet 110.

In operation, referring to FIGS. 2 and 4A-4C, a pressure of a fluid 402 (e.g., a liquid, gas, two-phase fluid, etc.) at the inlet 108 is applied to the disc 220, thereby generating a force and, thus, a pressure against the disc 220 (e.g., based on an area of the disc 220). The adjustor assembly 244 provides a preset or threshold pressure that must be overcome by the fluid 402 at the inlet 108 to move the fluid valve 100 from the closed position 200 of FIG. 2 to the open position 400 of FIG. 4A. For example, the force provided by the adjustor assembly 244 maintains the fluid valve 100 in the closed position 200 of FIG. 2 when a pressure of the fluid 402 at the inlet 108 does not exceed the preset pressure provided by the biasing element 248. Accordingly, a pressure of the fluid 402 at the inlet 108 exceeding a threshold pressure (e.g., set via the adjustor assembly 244) causes the fluid valve 100 to open to allow fluid to flow from the inlet 108, through the cage passageways 322 of the cage 218, and to the outlet 110 (e.g., to relieve pressure of a system and/or process fluid upstream from the fluid valve 100).

For example, when the pressure of the fluid 402 at the inlet 108 is substantially equal to the preset pressure provided by the adjustor assembly 244, the disc 220 moves slightly away from the nozzle seat 214 and the fluid 402 begins to leak or flow past the nozzle seat 214. As used herein, “cracking or crack pressure” means a pressure at which a total downward force exerted by the biasing element 248 and the weight of valve trim assembly 202 (i.e., the moving parts) of the fluid valve 100 is equal to an upward force exerted by the fluid 402 on the disc 220. A cracking pressure of the fluid valve 100 is typically less than a pressure which causes simmer. The cracking pressure is typically less than the simmer pressure, causing inaudible minor leakage to begin to flow. When pressure at the inlet 108 increases during simmer, the disc 220 moves further from the nozzle seat 214, allowing increased fluid flow through the fluid valve 100.

Referring to FIG. 4B, the disc 220 and/or the disc holder 222 is positioned within the central opening 232 of the cage 218 and the lip 308 surrounds at least a portion of the outer surface 234 of the disc holder 222. Additionally, there is a small clearance between the lip 308 and the disc holder 222 such that the fluid 402 does not flow between the disc holder 222 and the lip 308. For example, a diameter of the cage 218 (e.g., the lip 308) is approximately between 1 percent and 10 percent greater than a diameter of the disc holder 222 that is received by the central opening 232 of the cage 218. Thus, as the fluid 402 flows against the disc 220 and/or the disc holder 222, the disc holder 222 redirects the fluid 402 (e.g., downwardly) toward the cage passageways 322 of the cage 218. This redirection of the fluid 402 causes a huddling effect. The huddling effect, as noted above, causes fluid flow stagnation adjacent the nozzle seat 214 and/or the disc holder 222, thereby causing a local increase in pressure. The increased pressure provided by the huddling effect causes the disc 220 and the disc holder 222 to pop to the open position 400. Unlike a nozzle ring, the cage 218 provides adjustability of the fluid valve 100 action at a higher lift stroke or position. For example, the cage 218 can cause the disc 220 to pop or modulate open at, for example, fifty percent lift, a sixty percent lift, etc. For example, without the cage 218 or a nozzle ring, a fluid valve would simmer initially (e.g., between 0.1 percent open or lift and 10 percent open or lift) and then the fluid valve would pop open followed by a modulating action (e.g., during a second portion of lift (e.g., greater than fifty percent lift)). The cage 218 of the illustrated example restricts or prevents a modulating action during a second portion of lift (e.g., between 50 percent open or lift and 100 percent open or lift). For example, by enabling the disc 220 to pop open after simmer, the cage 218 of the illustrated example can reduce and/or eliminate a modulating effect that may otherwise occur between the fully closed position 200 and the fully open position 400 (e.g., between forty percent lift and one-hundred percent lift).

Referring to FIG. 4B, to adjust the huddling effect, the cage 218 of the illustrated example can be positioned at different locations along the end of the nozzle 206 between the nozzle seat 214 and a flared portion of the nozzle 206 (e.g., the cage 218 can be adjusted along a straight portion of the outer surface 228 or nozzle end). For instance, the cage 218 can be adjusted rectilinearly in a first direction 404 (e.g., an upward direction in the orientation of FIG. 4B) or a second direction 406 (e.g., a downward direction in the orientation of FIG. 4B) opposite the first direction 404 (e.g., vertically in the orientation of FIG. 4B) to adjust a huddling effect of the fluid valve 100. Thus, the cage 218 can be positioned closer to the disc 220 or farther away from the disc 220. The lower the cage 218 is positioned on the nozzle 206 (e.g., closer to the flared portion), the greater the huddling effect and/or boost pressure. The higher the cage 218 is positioned on the nozzle 206 (e.g., close to the nozzle seat 214), the lower the huddling effect and/or boost pressure. In other words, the greater the distance between the disc holder 222 and the cage base 310, the greater the amount of huddling effect. As the distance between the disc holder 222 and the cage base 310 reduces, the huddling effect also reduces, which reduces pressure boost. Additionally, referring to FIG. 4A, the lip 308 surrounds at least a portion of the outer surface 234 of the disc holder 222. The angle 316 (FIG. 3B) of the lip 308 can be varied during manufacturing to vary the huddling effect and/or valve performance. For example, the angle 316 of the lip 308 can be increased or decreased to adjust (e.g., increase or decrease) the huddling effect and/or an amount of boost pressure. In some examples, the angle 316 of the lip 308 can be smaller such that a larger sized clearance between the lip 308 and the disc holder 222 can be provided. Such larger clearance can affect huddling effect and/or other performance characteristics of the relief valve 100. As a result of varying the huddling effect via the position of the cage 218 and/or the angle 316 of the lip 308, the fluid valve 100 can be configured to provide different valve performance characteristics (e.g., different simmer effects during different stroke positions of the fluid valve 100 between fully open and fully closed, different pressures at which the relief valve pops open, etc.).

Referring to FIG. 4B, as pressure at the inlet 108 decreases, the disc 220 is urged toward the nozzle seat 214 by the biasing element 248 until the disc 220 engages the nozzle seat 214 to prevent fluid flow in the fluid valve 100. The cage 218 of the illustrated example can reduce or increase the blowdown by lowering or raising the position of the cage 218.

FIG. 5 is a perspective view of another example cage 500 disclosed herein.

Many of the components of the example cage 500 of FIG. 5 are substantially similar or identical to the components of the cage 218 described above in connection with FIGS. 1-3 and 4A-4C. As such, those components will not be described in detail again below. Instead, the interested reader is referred to the above corresponding descriptions for a complete written description of the structure and operation of such components. To facilitate this process, similar or identical reference numbers will be used for like structures in FIG. 5 as used in FIGS. 1-3. The cage 500 of FIG. 5 may be used to implement the fluid valve 100 of FIGS. 1-3 and 4A-4C (e.g., instead of the cage 218). For example, the cage 500 includes a lip 308, a base 310 (e.g., a mounting flange), a boss 320, and locating slots 326.

The cage 500 is substantially similar or identical to the cage 218 of FIGS. 1-3 except the cage 500 includes cage passageways 502 that are different than the cage passageways 322 of the cage 218. Each of the cage passageways 502 has a varying geometry (e.g., a tapering geometry in a direction along a longitudinal axis 314). For example, a first portion 504 of the cage passageways 502 has a first dimensional width and a second portion 506 of the cage passageways 502 has a second dimensional width that is different (e.g., less) than the first dimensional width. For example, each of the cage passageways 502 of the illustrated example have an inverted, trapezoidal shape. The cage passageways 502 are radially spaced relative to the longitudinal axis 314 about the circumference of the cage 500. The cage 500 of the illustrated example includes a plurality of walls or beams 508 that extend between the lip 308 and the base 310. Specifically, the beams 508 are radially spaced relative to the longitudinal axis 314 and/or the circumference of the cage 500. A respective one of the cage passageways 502 is positioned between respective ones of the beams 508. In some examples, the cage passageways 502 and/or the beams 508 can have a T-shaped, cross-sectional shape. In some examples, the cage passageways 502 and/or the beams 508 can have any other shape such as, for example, a square shape, a circular shape, an oblong or elliptical shape, triangular, etc. The cage passageways 502 define cage orifices that control a fluid flow characteristic and/or an amount of fluid flowing between the inlet 108 and the outlet 110.

FIG. 6 is a perspective view of the example fluid valve 100 of FIGS. 1-3 and 4A-4C having an example nozzle ring 600. Specifically, the nozzle ring 600 is coupled to the nozzle 206. In turn, the cage 218 is coupled to the nozzle ring 600. Thus, the nozzle ring 600 is positioned between the nozzle 206 and the cage 218. The inner surface 230 of the cage 218 (e.g., has threads 310a to) threadably couples to the nozzle ring 600. For example, the nozzle ring 600 includes inner threads 602 formed along at least a portion of an inner surface 604 of the nozzle ring 600 and external threads 606 formed along at least a portion of an outer surface 608 of the nozzle ring 600. Thus, the nozzle ring 600 couples to the nozzle 206 via the inner threads 602 and couples to the cage 218 via the external threads 606. The nozzle ring 600 can move along the nozzle 206 relative to the nozzle seat 214 in the rectilinear direction 255 (e.g., along the longitudinal axis 256). Additionally, the cage 218 is adjustable relative to the nozzle ring 600 and/or the nozzle seat 214 in the rectilinear direction 255. For instance, the nozzle ring 600 can be adjusted in the rectilinear direction 255 independently of the cage 218. Additionally, the cage 218 can be adjusted in the rectilinear direction 255 independently of the nozzle ring 600. The nozzle ring 600 includes locating slots (e.g., similar to the locating slots 326 of the cage 218) to receive the blowdown screw 264. The blowdown screw 264 maintains or locks a rotational position of the nozzle ring 600 to prevent rotation of the nozzle ring 600 about the longitudinal axis 256 during operation of the fluid valve 100.

The nozzle ring 600 can be employed in addition to the cage 218 to vary the huddling effect, simmer effect, a modulation effect, and/or any other performance characteristic of the fluid valve 100. For example, the nozzle ring 600 can be adjusted in the first direction 404 to move the nozzle ring 600 (e.g., upward in the orientation of FIG. 6) toward the nozzle seat 214 and the second direction 406 to move the nozzle ring 600 (e.g., downward in the orientation of FIG. 6) to move the nozzle ring 600 away from the nozzle seat 214.

In operation, the nozzle ring 600, in conjunction with the cage 218, can cause the disc 220 to reduce and/or eliminate simmer effect so that the valve can pop open and reach full lift close to the set pressure (e.g., within 1% lift of simmer). Additionally, the cage 218, in conjunction with the nozzle ring 600, can reduce or eliminate instances of modulation that can be caused by the nozzle ring 600 during operation. For instance, the nozzle ring 600 can provide a first huddling effect and/or a first pressure boost to open the fluid valve 100 along a first stroke or lift portion (e.g., a lower lift range between zero percent and fifty percent) and the cage 218 can provide a second huddling effect and/or a second pressure boost to continue opening (e.g. pop open) the fluid valve 100 along a second stroke or lift portion (e.g., an upper lift range between fifty percent and fully open or full lift position). Additionally, an amount of huddling effect provided by the nozzle ring 600 can be adjusted by moving the nozzle ring 600 along the nozzle 206 relative to the nozzle seat 214. For example, the huddling effect provided by the nozzle ring 600 decreases when the nozzle ring is lowered away from the disc 220 and increases when the nozzle ring 600 is raised closer to the disc 220. Thus, the nozzle ring 600 can be adjusted (e.g., vertically) relative to the nozzle 206 to control flow characteristics and/or performance of the fluid valve 100 over a first portion of lift (e.g., a lower half portion of lift). Additionally, as noted above, the cage 218 can be adjusted (e.g., vertically) relative to the nozzle 206 and/or the nozzle ring 600 to control flow characteristics and/or performance of the fluid valve 100 over a second portion of lift (e.g., an upper half portion of lift). In the illustrated example, the nozzle ring 600 can be adjusted independently of the cage 218 and the cage 218 can be adjusted independently of the nozzle ring 600.

Additionally, the nozzle ring 600 also improves and/or enables adjustment of blowdown. This in turn also affects a blowdown characteristic of the valve. As used herein, “blowdown” is the difference between the set pressure (the pressure at which the valve opens) and the reseating pressure (the pressure at which the valve closes). A raised nozzle ring 600 has longer blowdown (more product loss) and a lower nozzle ring 600 has a shorter blowdown (less product loss). Additionally, the cage 218 also provides adjustability of blowdown and/or modulation of the disc 220 relative to the nozzle seat 214. Both the nozzle ring 600 and cage 218 are closed coupled to control the valve action and blowdown. Thus, the nozzle ring 600 and the cage 218 can be adjusted to provide full control on shaping a lift design of the fluid valve 100. For example, the nozzle ring 600 and the cage 218 can be employed to improve, adjust, and/or modify an opening characteristic or performance of the fluid valve 100 as well as closing characteristic(s) or performance of the fluid valve 100. In some examples, the nozzle ring 600 and the cage 218 can retrofit existing fluid valves in the field.

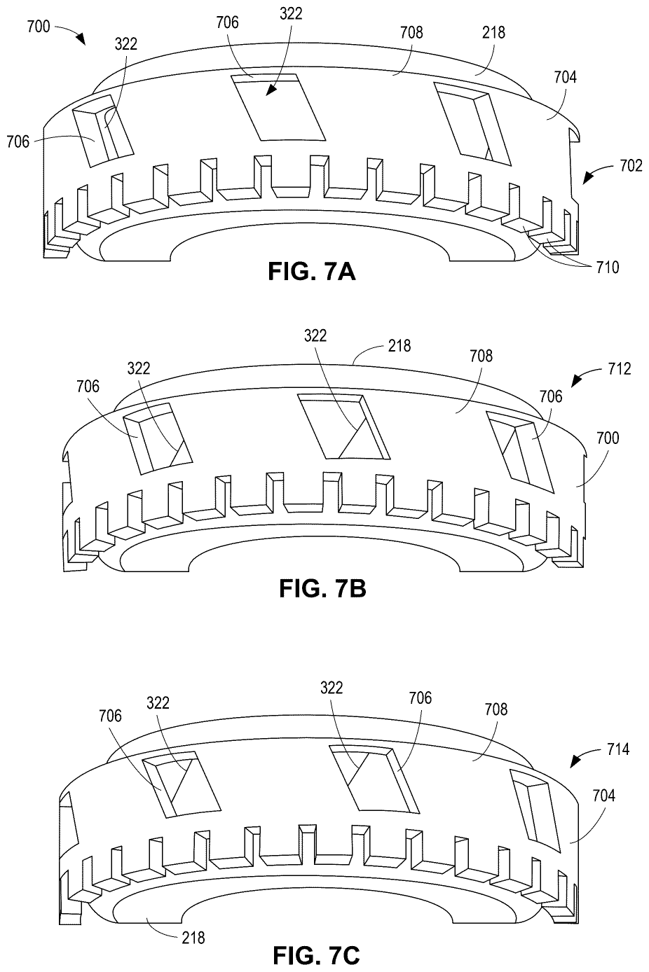

FIG. 7A is a partial perspective view of another example valve trim assembly 700 disclosed herein. The valve trim assembly 700 of FIG. 7A is shown in a first position 702. The valve trim assembly 700 of the illustrated example can be used to implement the relief valve of FIGS. 1-3, 4A-4C and/or 6. Specifically, the valve trim assembly 700 of the illustrated example includes the cage 218 of FIGS. 1-3 and a flow control ring 704 (e.g., a flow adjusting ring). In some examples, the valve trim assembly 700 can include the nozzle ring 600 of FIG. 6. The flow control ring 704 is coupled (e.g., movably, or rotatably) to the cage 218. The flow control ring 704 includes a plurality of second openings 706 radially spaced along a side wall 708 of the flow control ring 704. In other words, the second openings 706 are radially spaced about a circumference of the flow control ring 704. The second openings 706 of the flow control ring 704 align with respective ones of the cage passageways 322 of the cage 218. The flow control ring 704 moves or rotates relative to the cage passageways 322 of the cage 218 to adjust (e.g., increase or decrease) a flow area of the cage passageways 322 to affect fluid flow characteristics of a fluid flowing through the cage passageways 322 of the cage 218. For example, the flow control ring 704 is movably adjustable relative to the cage 218. For example, the flow control ring 704 of the illustrated example is shown in the first position 702 in FIG. 7A. In the first position 702, the second openings 706 align with the cage passageways 322 such that the flow control ring 704 does not obstruct or impede flow through the cage passageways 322. In other words, the flow control ring 704, in the first position 702, does not reduce a flow area (e.g., a collective flow area) of the cage passageways 322 and allows full flow (e.g., one-hundred percent flow) through the cage passageways 322. The flow control ring 704 rotates relative to the cage 218 between the first position 702 such that the flow control ring 704 (e.g., the side wall 708) does not obstruct the cage passageways 322 and a second position such that the side wall 708 obstructs or impedes flow through at least a portion of the cage passageways 322. The flow control ring 704 of the illustrated example includes a plurality of locating slots 710 to receive the blowdown screw 264 of FIG. 2. The locating slots 710 are radially spaced about a circumference of the flow control ring 704. The locating slots 710 align with the locating slots 326 of the cage 218 and/or locating slots of the nozzle ring 600. The flow control ring 704 can be slidably or rotatably coupled to the cage 218 via a track and pin, a tongue and groove connection, threads, a slider, and/or any other rotating technique(s) to rotatably couple the flow control ring 704 relative to the cage 218. For example, the flow control ring 704 can include one of a slot or pin and the cage 218 can include another one of the slot or pin to rotatably couple the flow control ring 704 and the cage 218.

FIG. 7B is a partial perspective of the example valve trim assembly 700 of FIG. 7B, but shown in a second example position 712 relative to the cage 218. In the second position 712, the flow control ring 704 is positioned to partially obstruct or impede fluid flow through the cage passageways 322. Specifically, in the second position 712, the cage passageways 322 are partially blocked by the side wall 708 of the flow control ring 704 to prevent, restrict or impede fluid flow passing through (e.g., the blocked area of) the cage passageways 322. Thus, in FIG. 7B, the cage passageways 322 of the cage 218 are partially obstructed (e.g., between 30 percent and 50 percent blocked) such that a flow area (e.g., a collective flow area) provided by the cage passageways 322 is reduced compared to the flow area provided through the cage passageways 322 when the flow control ring 704 is in the first position 702.

FIG. 7C is a partial perspective of the example valve trim assembly 700 of FIG. 7A, but shown in a third example position 714 relative to the cage 218. In the third position 714, the flow control ring 704 further obstructs or blocks the cage passageways 322. For example, the cage passageways 322 are partially obstructed (e.g., between approximately 70 percent and 90 percent) by the side wall 708 of the flow control ring 704. Thus, in FIG. 7C, the cage passageways 322 are partially obstructed by the side wall 708 such that a flow area (e.g., a collective flow area) provided by the cage passageways 322 is reduced by a greater amount than the flow area of the cage passageways 322 provided when the flow control ring 704 is in the second position 712 shown in FIG. 7B.

Additionally, the flow control ring 704 of the illustrated example can be employed to limit the flow through the fluid valve 100 at infinite intervals. For example, some valves employ a spacer or washer between the disc holder 222 and the bonnet 104 and/or the guide 236 to limit a full stroke length or lift of a fluid valve 100 to control the maximum flow through the fluid valve 100. Installing such a spacer requires disassembly of the fluid valve 100. However, the example flow control ring 704 can be positioned, for example, in the third position 714 and/or any other position that partially blocks or impedes fluid flow through the cage passageways 322 to provide the required flow through the valve.

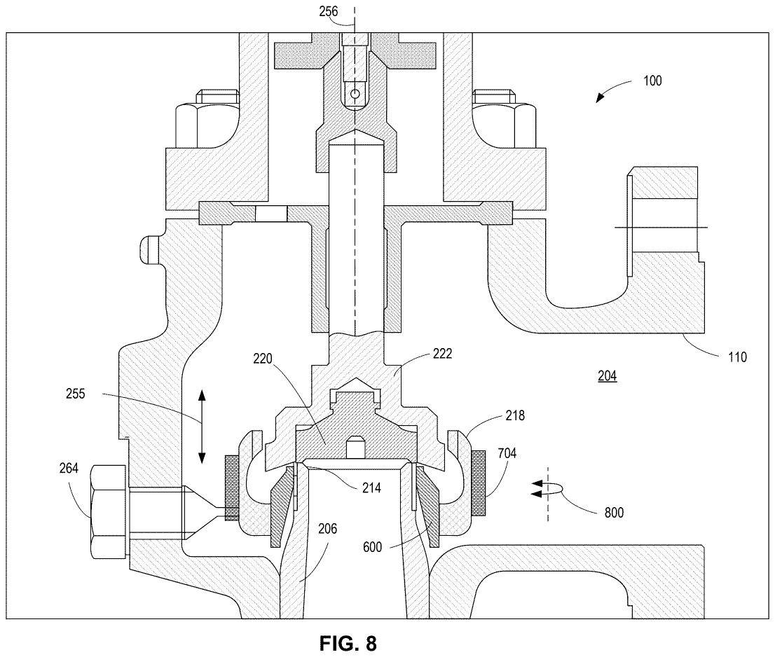

FIG. 8 is a cross-sectional view of the example fluid valve 100 of FIGS. 1-3, but implemented with the example valve trim assembly 700 of FIGS. 7A-7C. Additionally, the valve trim assembly 700 includes the nozzle ring 600. In the illustrated example, the flow control ring 704 is rotatably or slidably coupled to the cage 218. In turn, the cage 218 is coupled to the nozzle ring 600. Thus, in this example, the nozzle ring 600 can be adjusted in the rectilinear direction 255 (e.g., a vertical direction in the orientation of FIG. 8) relative to the nozzle seat 214. The cage 218 can be adjusted in a rectilinear direction 255 (e.g., a vertical direction in the orientation of FIG. 8) relative to the nozzle ring 600 and/or the nozzle seat 214. Additionally, the flow control ring 704 can be adjusted and/or rotated relative to the cage 218 in a rotational direction 800 about the longitudinal axis 256 of the fluid valve 100. The blowdown screw 264 engages respective ones of the locating slots 326, 710 of the cage 218, the nozzle ring 600 and the flow control ring 704 to lock a position of the cage 218, the nozzle ring 600 and the flow control ring 704. In this manner, the blowdown screw 264 prevents movement of the cage 218 and nozzle ring 600 in the rectilinear direction 255 and prevents rotation of the flow control ring 704 relative to the cage 218 in the rotational direction 800.

The nozzle ring 600 can be adjusted independently of the cage 218 and/or the flow control ring 704, the cage 218 can be adjusted independently of the nozzle ring 600 and/or the flow control ring 704, and the flow control ring 704 can be adjusted independently from the nozzle ring 600 and/or the cage 218. Thus, the nozzle ring 600 and the cage 218 can be adjusted rectilinearly (e.g., vertically) to adjust a huddling effect, a simmer effect, a pop pressure, a modulating effect and/or any other effect between a fully closed position (e.g., the closed position 200 of FIG. 2) and a full lift open position (e.g., the open position 400 of FIG. 4). Additionally, the flow control ring 704 can be rotatably adjusted relative to the cage 218 to affect a flow characteristic and/or fluid flow through the cage passageways 344 as fluid flows between the inlet 108 and the outlet 110. In some examples, the nozzle ring 600 of the illustrated example can be omitted and the cage 218 can couple directly to the nozzle 206 and the flow control ring 704 can couple directly to the cage 218.

Although each example valve seat assemblies disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features. For example, the cage 218 and the flow control ring 704 can be used without the nozzle ring 600.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part.

As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to improve performance, manufacturing, and/or assembly of relief valves are disclosed herein. Further examples and combinations thereof include the following:

Example 1 includes a trim assembly for a pressure relief valve, the trim assembly comprising a cage having a lip tapered toward a central axis of the cage, a mounting flange spaced from the lip, and a body between the lip and the mounting flange, the body including a plurality of first openings radially spaced about a circumference of the body.

Example 2 includes the trim assembly of example 1, further including a disc and a disc holder to retain the disc, the disc holder to be received by a central opening of the cage.

Example 3 includes the trim assembly of any one of examples 1-2, wherein the lip surrounds at least a portion of an outer surface of the disc holder.

Example 4 includes the trim assembly of any one of examples 1-3, wherein the lip has an angle of approximately between 40 degrees and 60 degrees from an outer surface of the body.

Example 5 includes the trim assembly of any one of examples 1-4, further including a nozzle to couple to a valve body of the pressure relief valve.

Example 6 includes the trim assembly of any one of examples 1-5, wherein the cage couples to an end of the nozzle.

Example 7 includes the trim assembly of any one of examples 1-6, further including a nozzle ring coupled to the nozzle.

Example 8 includes the trim assembly of any one of examples 1-7, wherein the nozzle ring includes inner threads and outer threads, the inner threads formed along at least a portion of an inner surface of the nozzle ring and the outer threads formed along at least a portion of an outer surface of the nozzle ring.

Example 9 includes the trim assembly of any one of examples 1-8, wherein the nozzle ring couples to the nozzle via the inner threads and the nozzle ring couples to the cage via the outer threads.

Example 10 includes the trim assembly of any one of examples 1-9, further including a flow control ring coupled to the cage.

Example 11 includes the trim assembly of any one of examples 1-10, wherein the flow control ring includes a plurality of second openings radially spaced along a side wall of the flow control ring.

Example 12 includes the trim assembly of any one of examples 1-11, wherein the flow control ring is movable relative to the cage.

Example 13 includes the trim assembly of any one of examples 1-12, wherein the second openings of the flow control ring align with respective ones of the first openings of the cage to define a portion of a flow path for a fluid flowing through the cage.

Example 14 includes a pressure relief valve comprising a valve body defining a fluid passageway between an inlet and an outlet, a nozzle coupled to the valve body, the nozzle defining the inlet of the valve body, the nozzle having a sealing surface defining an orifice of the fluid passageway, a disc holder movably coupled to the valve body, the disc holder to move relative to sealing surface to control fluid flow through the fluid passageway, and a cage coupled to the nozzle, the cage having a lip tapered toward a central axis of the cage.

Example 15 includes the pressure relief valve of example 14, wherein the cage includes an inner surface having threads to threadably couple to the nozzle.

Example 16 includes the pressure relief valve of any one of examples 14-15, further including a nozzle ring coupled to the nozzle, the cage having an inner surface that includes threads to threadably couple to the nozzle ring.

Example 17 includes the pressure relief valve of any one of examples 14-16, further including a flow control ring, the flow control ring movably coupled relative to the cage, the flow control ring to adjust a size of an opening of a cage to effect fluid flow characteristics of a fluid flowing through the opening of the cage.

Example 18 includes a trim assembly for a pressure relief valve including a disc, a disc holder to retain the disc, a nozzle, the disc to move relative to the nozzle to control fluid flow through a fluid valve, and a cage having a central bore to slidably receive the disc, the cage having a first end and a second end opposite the first end and a side surface between the first and second ends, the side surface having a plurality of passages radially spaced relative to a longitudinal axis of the central bore, the cage including a boss protruding within the central bore and extending from the second end toward the first end.

Example 19 includes the trim assembly of example 18, further including a nozzle ring coupled to the nozzle, wherein the cage is coupled to the nozzle ring.

Example 20 includes the trim assembly of any one of examples 18-19, further including a flow adjusting ring coupled to the cage, the flow adjusting ring rotatable relative to the cage to adjust a flow area of the passages.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A trim assembly for a pressure relief valve, the trim assembly comprising:
a cage having:
a lip tapered toward a central axis of the cage;
a mounting flange spaced from the lip; and
a body between the lip and the mounting flange, the body including a plurality of first openings radially spaced about a circumference of the body.

2. The trim assembly of claim 1, further including a disc and a disc holder to retain the disc, the disc holder to be received by a central opening of the cage.

3. The trim assembly of claim 2, wherein the lip surrounds at least a portion of an outer surface of the disc holder.

4. The trim assembly of claim 1, wherein the lip has an angle of approximately between 40 degrees and 60 degrees from an outer surface of the body.

5. The trim assembly of claim 1, further including a nozzle to couple to a valve body of the pressure relief valve.

6. The trim assembly of claim 5, wherein the cage couples to an end of the nozzle.

7. The trim assembly of claim 5, further including a nozzle ring coupled to the nozzle.

8. The trim assembly of claim 7, wherein the nozzle ring includes inner threads and outer threads, the inner threads formed along at least a portion of an inner surface of the nozzle ring and the outer threads formed along at least a portion of an outer surface of the nozzle ring.

9. The trim assembly of claim 8, wherein the nozzle ring couples to the nozzle via the inner threads and the nozzle ring couples to the cage via the outer threads.

10. The trim assembly of claim 6, further including a flow control ring coupled to the cage.

11. The trim assembly of claim 10, wherein the flow control ring includes a plurality of second openings radially spaced along a side wall of the flow control ring.

12. The trim assembly of claim 11, wherein the flow control ring is movable relative to the cage.

13. The trim assembly of claim 12, wherein the second openings of the flow control ring align with respective ones of the first openings of the cage to define a portion of a flow path for a fluid flowing through the cage.

14. A pressure relief valve comprising:
a valve body defining a fluid passageway between an inlet and an outlet;
a nozzle coupled to the valve body, the nozzle defining the inlet of the valve body, the nozzle having a sealing surface defining an orifice of the fluid passageway;
a disc holder movably coupled to the valve body, the disc holder to move relative to sealing surface to control fluid flow through the fluid passageway; and
a cage coupled to the nozzle, the cage having a lip tapered toward a central axis of the cage.

15. The pressure relief valve of claim 14, wherein the cage includes an inner surface having threads to threadably couple to the nozzle.

16. The pressure relief valve of claim 14, further including a nozzle ring coupled to the nozzle, the cage having an inner surface that includes threads to threadably couple to the nozzle ring.

17. The pressure relief valve of claim 16, further including a flow control ring, the flow control ring movably coupled relative to the cage, the flow control ring to adjust a size of an opening of a cage to effect fluid flow characteristics of a fluid flowing through the opening of the cage.

18. A trim assembly for a pressure relief valve comprising:
a disc;
a disc holder to retain the disc;
a nozzle, the disc to move relative to the nozzle to control fluid flow through a fluid valve; and
a cage having a central bore to slidably receive the disc, the cage having a first end and a second end opposite the first end and a side surface between the first and second ends, the side surface having a plurality of passages radially spaced relative to a longitudinal axis of the central bore, the cage including a boss protruding within the central bore and extending from the second end toward the first end.

19. The trim assembly of claim 18, further including a nozzle ring coupled to the nozzle, wherein the cage is coupled to the nozzle ring.

20. The trim assembly of claim 18, further including a flow adjusting ring coupled to the cage, the flow adjusting ring rotatable relative to the cage to adjust a flow area of the passages.
